(19) United States
(12) Patent Application Publication
(10) Pub. No.: US 2009/0271725 A1
(43) Pub. Date: Oct. 29, 2009

(54) System and Method for Rack management and Capacity Planning

(76) Inventor: Fred Dirla, Bridgewater, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/108,508

(22) Filed: Apr. 24, 2008

(51) Int. Cl. G06F 3/00

(52) U.S. Cl. 715/771

(57) ABSTRACT

A system and method for monitoring, at a Web browser, electrical components can include the steps of receiving, information related to electrical components, such as servers, disposed in a plurality of cabinets, a portion of the cabinets being located in a first geographic location, and a second portion of the cabinets being located in a second geographic location, remote from the first geographic location, receiving information related to the real-time characteristics of the electrical components and displaying a graphical representation of the cabinets, the components and the information related to the real-time characteristics of the electrical components. The information related to the electrical components can include which cabinet the electrical components are located, the rated current draw of the electrical component, and the rated temperature of the electrical component. The real-time characteristics of the electrical components can include the actual percentage of rated current load, the actual percentage of rated temperature, and the actual percentage power draw. Displayed views can include a cabinet view, a room view, a floor view, a building view, a state view, a country view and a world view.

### CROSS REFERENCE TO RELATED APPLICATION

This application claims the benefit of U.S. Provisional Patent application No. 60/913,313, filed Apr. 23, 2007, the contents of which are hereby incorporated by reference herein.

### FIELD OF THE INVENTION

Embodiments of the invention relate generally to electrical systems, and more particularly to systems and methods for rack management and capacity planning for distributed electrical systems such as high-density server installations.

### BACKGROUND OF THE INVENTION

In today's business environment, the success of many corporations and business enterprises is dependent upon a vast internal information technology infrastructure that includes hundreds or thousands of servers and other computer devices distributed throughout the enterprise.

These servers are typically housed in special environmentally controlled rooms that contain rows of electrical cabinets. Each electrical cabinet can contain one or more servers, as well as electrical power distribution components. Electricity is distributed through branch circuits to power the servers and other components in the cabinets.

As the needs of different business units within an organization change and grow, it is often necessary to add additional servers into the organization's information technology infrastructure. As decisions are made as to where to ad additional servers, capacity planning for adding additional servers, and/or moving servers can become complex and cumbersome. Keeping track of available electrical loads, HVAC capacities, and cabinet capacities as well as other pertinent information related to the deployment of servers and other electrical equipment throughout the organization is ever more important and complex.

In addition, overloaded and unbalanced circuits can cause catastrophic failures which can lead to loss of data and stop business units from performing necessary functions. Thus, it would be helpful to be able to monitor these circuits throughout the enterprise

Moreover, many large business enterprises have physical assets spread across the globe. Currently, facility departments and information technology departments lack a unified integrated system or tool to implement capacity and facility planning and to monitor electrical equipment assets located at a plurality of sites for a large distributed enterprise. For example, an information technology firm having sites distributed at locations throughout the world may have hundreds of locations each requiring capacity and facility planning, as well as monitoring and evaluation. Located within these hundreds of locations may be tens of thousands of pieces of energy consuming equipment, which contribute to the overall equipment deployment profile of each site and of the enterprise.

Accordingly, what would be desirable, but has not yet been provided, is a centrally located, user-friendly system for capacity and facility planning as well as tracking or monitoring of electrical characteristics of equipment located at one or more sites distributed at multiple geographic locations.

### SUMMARY OF THE INVENTION

The above-described problems are addressed and a technical solution is achieved in the art by providing systems and methods for implementing capacity and facility planning and monitoring, of electrical equipment located at multiple sites. The systems of some embodiments make it possible to view a plurality of data centers, which can be spread all over the world, as a single united entity. The system includes a plurality of PCs/Workstations that are Web-enabled, a Web server, and a database server which includes information relating to pieces of energy consuming equipment located at one or more sites distributed at multiple geographic locations.

A system and method for facility planning can include the steps of receiving information related to electrical components, such as servers disposed in a plurality of cabinets, receiving information related to the real-time characteristics of the electrical components and displaying a graphical representation of the cabinets, the components and the information related to the real-time characteristics of the electrical components. The information related to the electrical components can include which cabinet the electrical components are located the rated current draw of the electrical component, and the rated temperature of the electrical component. The real-time characteristics of the electrical components can include the actual percentage of rated current load the actual percentage of rated temperature, and the actual percentage power draw. Displayed views can include a cabinet view, a room view, a floor view, a building view, a state view, a country view and a world view.

Thus, by way of embodiments of the invention, systems and methods are provided for tracking or monitoring) of electrical characteristics of equipment located at one or more sites distributed at multiple geographic locations.

### BRIEF DESCRIPTION OF THE DRAWINGS

Embodiments of the invention will be more readily understood from the detailed description of exemplary embodiments presented below considered in conjunction with the attached drawings, of which:

FIG. 1A is a block diagram showing a system architecture in accordance with an embodiment of the present invention;

FIG. 1B is a block diagram showing a system architecture in accordance with another embodiment of the present invention;

FIG. 2 is a block diagram of a software architecture, constructed in accordance with embodiments of the present invention;

FIG. 3 is a flow diagram of the navigation of user screens, constructed in accordance with embodiments of the present invention;

FIG. 4 is screen shot of Web page which displays a world map in accordance with embodiments of the present invention;

FIG. 5 is screen shot of Web page which displays a country map in accordance with embodiments of the present invention;

FIG. 6 is screen shot of Web page which displays a locations screen in accordance with embodiments of the present invention;

FIG. 7 is screen shot of Web page which displays a floor screen in accordance with embodiments of the present invention;

FIG. 8 is screen shot of Web page which displays a room screen according to equipment by occupancy in accordance with embodiments of the present invention;

FIG. 9 is screen shot of Web page which displays a room screen according to equipment by alarms in accordance with embodiments of the present invention;

FIG. 10 is screen shot of Web page which displays a rack/cabinet watt load in accordance with embodiments of the present invention;

FIG. 11 is screen shot of Web page which displays a heat map in accordance with embodiments of the present invention;

FIG. 12 is screen shot of Web page which displays a PDU Distribution in accordance with embodiments of the present invention;

FIG. 13 is screen shot of Web page which displays a report by design/load overview in accordance with embodiments of the present invention;

FIG. 14 is screen shot of Web page which displays a report generated for a particular PDU according to PDU detail, showing actual load conditions in detail in accordance with embodiments of the present invention;

FIG. 15 is screen shot of Web page which displays rack detail in accordance with embodiments of the present invention;

FIGS. 16-17 are screen shots of Web pages which displays panel detail in accordance with embodiments of the present invention;

FIG. 18 is screen shot of Web page which displays an edit panel screen after selecting the Room Overview tab;

FIG. 19 is screen shot of Web page which displays load detail vs. time from the panel detail screen; and

FIGS. 20A-20H are details of data tables stored in the database server of embodiments of the present invention.

It is to be understood that the attached drawings are for purposes of illustrating the concepts of the invention and may not be to scale.

### DETAILED DESCRIPTION

Embodiments of the present invention are directed to a system and method and software application that provides real time and historical branch circuit monitoring, circuit alarm notification, and cabinet asset management for small and large data centers. The system of the present invention makes it possible to view a plurality of data centers, which can be spread all over the world, as a single entity. The present system bridges the gap between facility infrastructure and cabinet management for power capacity planning. The system can display compiled energy usage data to allow for proper distribution of equipment in a data center to avoid overloading, of circuits and cabinets. An enterprise can predict alarms/excessive power dissipation conditions and make it possible for an enterprise to make decisions concerning load balance and upgrades to their systems based on power dissipation in a centralized fashion from any of a plurality of distributed terminals. Features of certain embodiments can include one or more of: A non-proprietary, browser-based user interface; Input/Output (I/O) capability for detailed cabinet and room environmental monitoring; Simple Network Management Protocol (SNMP) and email alarm notification; Ethernet and MODBUS communications; SQL database for report generation; The addition and modification of rooms, cabinets, and circuits; and An automatic audit trail for tracking changes made by a user.

The system of some embodiments can simplify capacity planning and accelerate the speed of high-density server deployment. The system is capable of tracking and recording additions, movements, and deletions in branch circuits. The system can track load vs. available AC power and cabinet capacities within a data center. The system can depict graphically dynamic power variations at the circuit, cabinet, room, and facility level, and can provide automated alarms in real time.

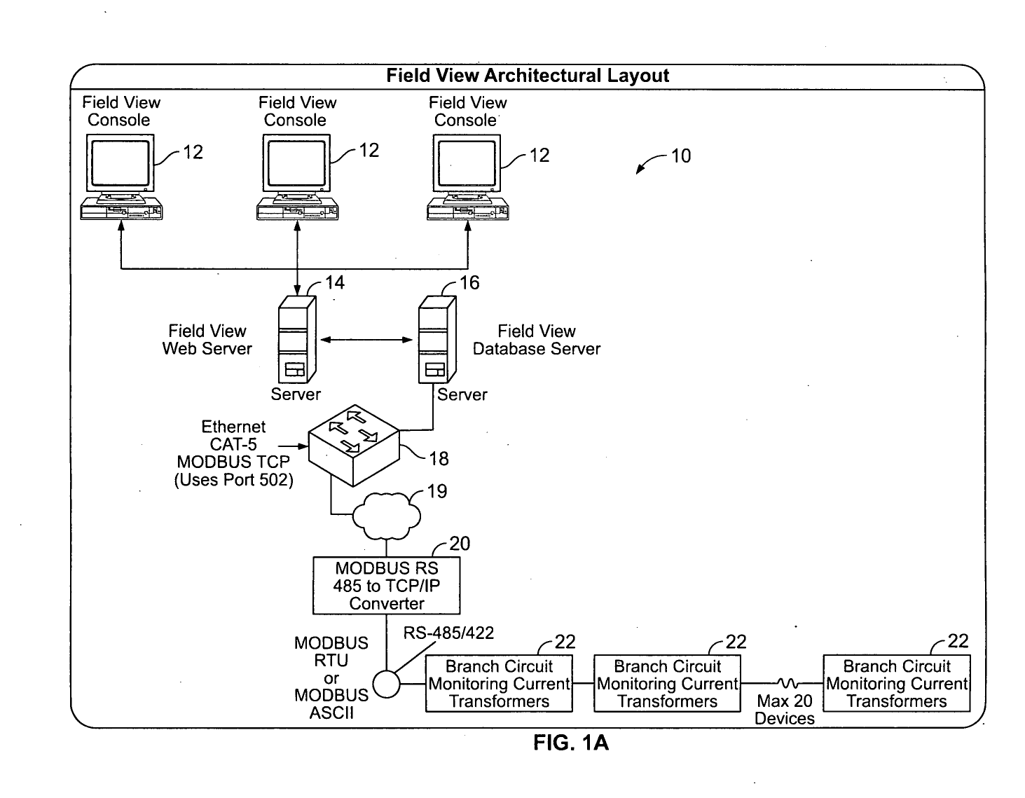

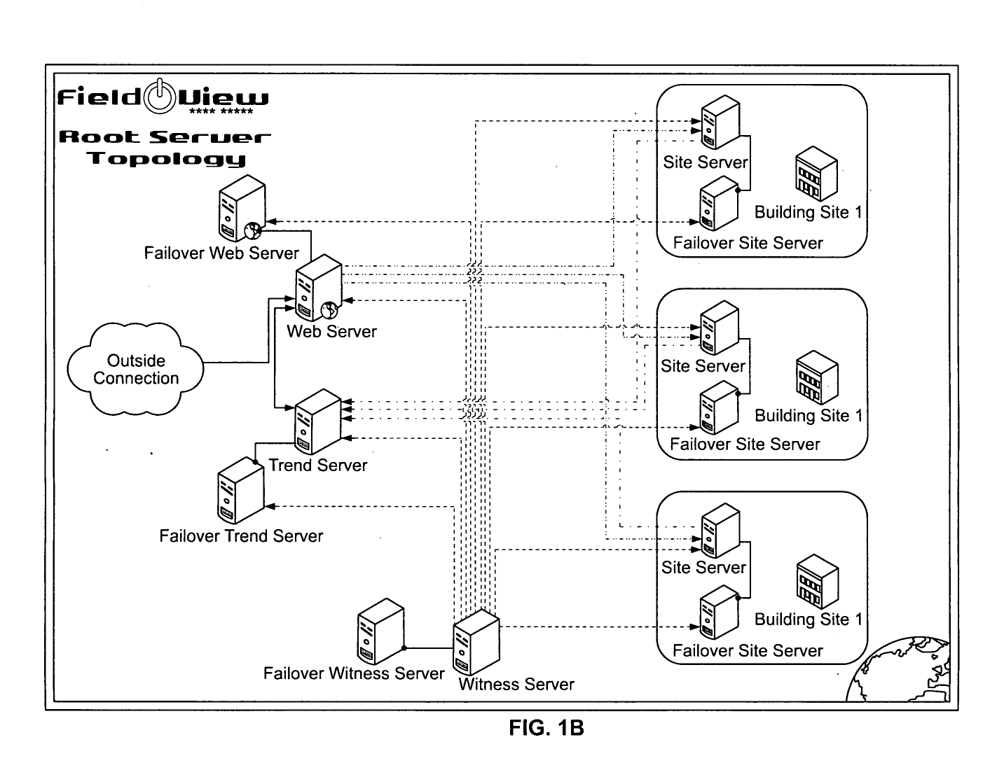

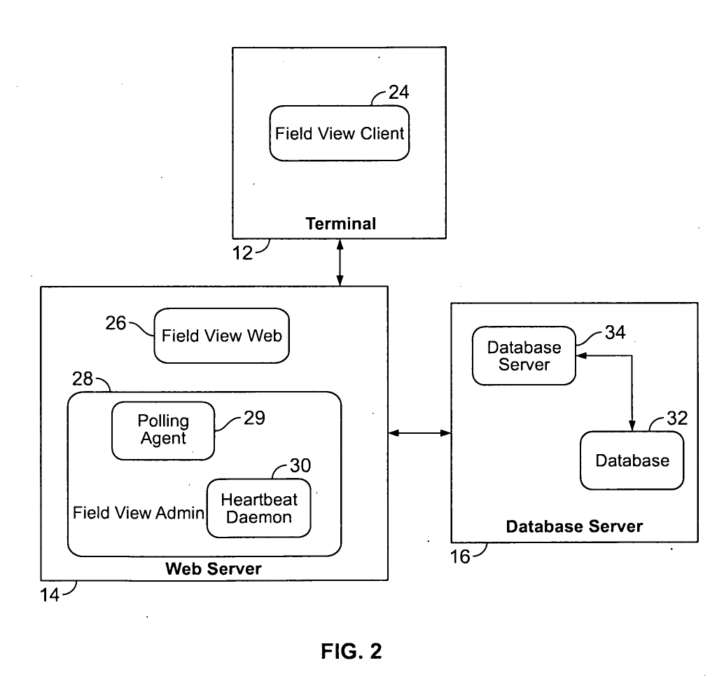

Referring to FIG. 1A, an exemplary system architecture of the present invention is depicted, in accordance with an embodiment of the present invention, generally, indicated at 10. The system 10 includes a plurality of Web-enabled terminals 12, which can be PCs or workstations, a Web server 14, a database server 16, a plurality an of Ethernet to MODBUS TCP converters 18, a plurality of MODBUS RS-485 to TCP/IP converters 20, a plurality of MODBUS splitters (not shown), I/O Blocks (not shown), and a plurality of branch circuit current transformers 22. The system can be communicatively coupled to a network, such as the Internet 19. In a preferred embodiment, the Web-enabled terminals 12 include a monitor which supports a resolution of up to 1680×1050 pixels. The PC/Workstation 12 cain be configured to run the following application programs: Microsoft Windows 2000/XP™ operating system, Internet Explorer™ Version 5.0 or higher Visual Interdev 6.0, Microsoft SQL Server 2000™, Microsoft Office 2003™, Macromedia Flash, HTML guardian, Safenet Sentinel License Designer, Fusion Charts, CimQuest Ingear, Front Page Extensions and permissions, and Paint Shop Pro. In one embodiment, the servers 14, 16 can preferably be a Pentium 4 or higher running at 2.8 GHz with 2 GB of RAM and 146 GB Raid 5 hard disks. The Web server 14 includes an HTTP server, WEB GUI tools, and an application server running under a version of the Windows operating system. The servers 14, 16 can be configured to run Microsoft SQL Server 2000 with Service Pack 4, IIS 6.0, and Windows 2003 Server with Front Page Extensions.

The integration of a database into the system 10 is via interactions between the Web server 14 and the database server 16, and is transparent to the browsers running on the terminals 12. When a Web browser on a terminal 12 requests a data page from the Web server 14, the Web server 14 uses an application program to access the database via an ODBC driver, generates an HTML-data page on-the-fly, then passes the page from the database server 16 directly to the Web browser on a terminal 12. The Web server 14 can be thought of as the portal to the World Wide Web of the Internet 19 from the point of view of the operating system running on the Web server 14, and by network connection and extension, to the Web-enabled terminals 12. The Web server 12 provides a facade to the operating system's resources by encapsulating the operating system and providing the requested resources to the browser on the terminals 12 using the functionality of the local operating system of the terminals 12. A client application program running on a terminal 12 can use a Web browser to contact the Web server 14 and use HTTP to ask the Web server 14 for a specific document. The Web server 14 would then send the requested document back to the Web browser which, in turn, would display the document via the client program running on the terminal 12.

For database connectivity, embodiments of the invention can be developed by use of IDC, which is an ISAPI dynamic link library (DLL) that uses ODBC to gain access to databases, which allows the creation of Web pages dynamically from a database. To publish database information on the Web using IDC, an .IDC file can be created that resides on an IIS server residing on the Web server 14. .IDC can be created. An .IDC file is a text file that specifies an ODBC data source and login information as well as queries programmed in SQL to retrieve/update data. An .HTX file is also created to act as a formatting template for any retrieved results. The .IDC file references the .HTX file so that the database information can be formatted to display in an HTML page. Finally, a developer can create a Web page that passes a reference to a specific .IDC file in order to connect to and access the database from a Web browser on a terminal 12.

Embodiments of the invention can be developed by use of Visual InterDev, a program which provides a complete development system for building Web applications. Visual InterDev includes client- and server-side programming tools, database connectivity tools, content editing tools, publishing and site management abilities, and team-based development support. Visual InterDev relies on a technology from Microsoft IIS called Active Server Pages. An Active Server Page is where application logic is stored. A Web developer can use server-side scripting languages, stick as MS VB script and JScript, to perform application processing directly on the Web server 14. With Active Server Pages, a Web developer can build dynamic Web applications with advanced state management, server-side scripting, and server components. MS Visual InterDev also supports client-side scripting languages, such as VRScript, JScript, and ActiveX controls.

In some embodiments, the system 10 is adapted to monitor the current draw from equipment located on racks residing in rooms on floors of enterprise buildings which may be distributed throughout the world. Some embodiments makes use of MODBUS connectivity for access to measurement circuitry from the database server 16. Connectivity to the Web is via an ethernet-to-MODBUS TCP converter 18, located with the database server 16, and a plurality of MODBUS TCP/IP-to-RS-485 multi-point-to-multipoint converters 20 located at the power distribution sites distributed over the Web via the Internet 19. The converters 20 use Port 6110, Lantronix Xpress DR+, and Square D EX100SD. The MODBUS splitters (nots shown) employ SCADLINK IP Gateway.

Using, the MODBUS standard hardware/software for the present invention has many advantages over other automated data acquisition standards such as: in addition to hardware, MODBUS is also an application layer messaging protocol, positioned at level 7 of the OSI model, which provides client/server communication between devices connected on different types of buses or networks; Modbus can allow up to millions of automation devices to communicate. MODBUS devices can be accessed at a reserved system port 502 on the TCP/IP stack; and MODBUS is a request/reply protocol and offers services specified by function codes.

MODBUS function codes are elements of MODBUS request/reply PDUs; MODBUS is an application layer messaging protocol for client/server communication between devices connected on different types of buses or networks; MODBUS can be implemented using: TCP/IP over Ethernet; Asynchronous serial transmission over a variety of media (wire: EIA/TIA-232-E. EIA-422, EIA/TIA-485-A; fiber, radio, etc.); and MODBUS PLUS, a high speed token passing network.

The I/O blocks for connecting from the MODBUS TCP/IP-to RS-485 converters 20 from/to the branch circuit monitoring current transformers 22 can be Microbrick UI81. The branch circuit monitoring (BCM) current transformers 22 can be either Veris H663 Modbus Split-Core BCMs or Veris H704 Modbus Split-Core BCMs. Communications interfaces between the system 10 and other systems is possible via MODBUS Port 502, SQL Port 1433, HTTP Web Port 80. SMPT Port 25 and SNMP.

Referring to FIG. 1B, another exemplary system architecture of the present invention is shown, making use of a trend server, site servers, building servers, wireless servers, and one or more failover servers.

Referring now to FIG. 2, the software architecture of the present invention is depicted. The software architecture include a Web browser program 24 running on the terminals 12, a Field View Web application 26 running on the Web server 14, a Field View Admin application 28 running on the Web Server 14, a polling agent 29 running within the Field View Admin application 28, a heartbeat daemon 30 running within the Field View Admin application 28, an SQL-query-able database 32 stored on the database server 16, and a database server program 34 for access to/from the database 32 running on the database server 16. The field View Web application 26 communicates with the database server 16 via ODBC. The Field View Web application 26 was developed using the Microsoft Internet Server API and runs as an extension of the Microsoft Internet Information Server (IIS), The Field View Web application 26 is configurable and allows for thousands of concurrent users to access the system 10. The Web browser program 24 provides a browser-based user interface on each of the terminals 12. The Web browser program 24 can communicate with the Field View Admin application 28 and the database server program 34 via ODBC. The Field View Admin application 28 configures all aspects of the system 10 including providing the real time branch circuit monitoring, alarm notification, and cabinet asset management functions of the system 10.

Upon start up of the system 10, Field View Admin application 28 can perform the one or more of following system checks: License Key information; SQL Server Database Connection; and/or User Permissions

The Field View Admin application 28 initializes the polling agent 29 and tile heartbeat daemon 30. The Polling Agent 29 collects current measurement data using the ModBus Interfaces 18, 20. It continuously scans the circuits of each panel via the plurality of branch circuit current transformers 22 and gets the data which in turn is updated in the SQL Server Database 32. In some embodiments, the Polling Agent 29 scans approximately 200 Circuits per second and simultaneously. Circuit Alarms due to overloads can be generated at the same time based on the severity level. The following are the different types of alarms that can be generated: Team Circuit Critical High Alarm; Team Warning High Alarm; Team Circuit Warning Low Alarm; Circuit Critical High Alarm; Circuit Warning High Alarm; Circuit Warning Low Alarm; and Commission Failure.

The Heartbeat Demon 30 keeps track of the Polling Agent 29. If the Heartbeat Daemon 30 determines that there is no response from or failure of the Polling Agent 29, then the Heartbeat Daemon 30 restarts the Polling Agent 29. An Email is generated by the Heart Beat Daemon 30 if it fails to start the Polling Agent 29 with in the time span of 15 minutes.

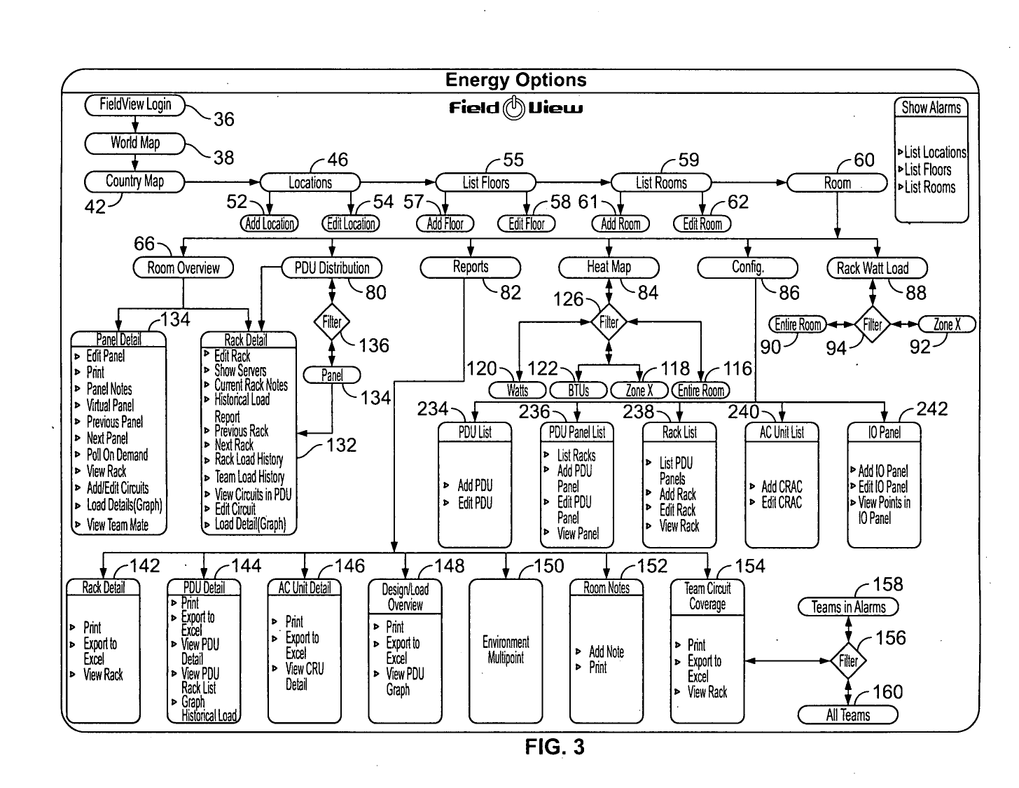

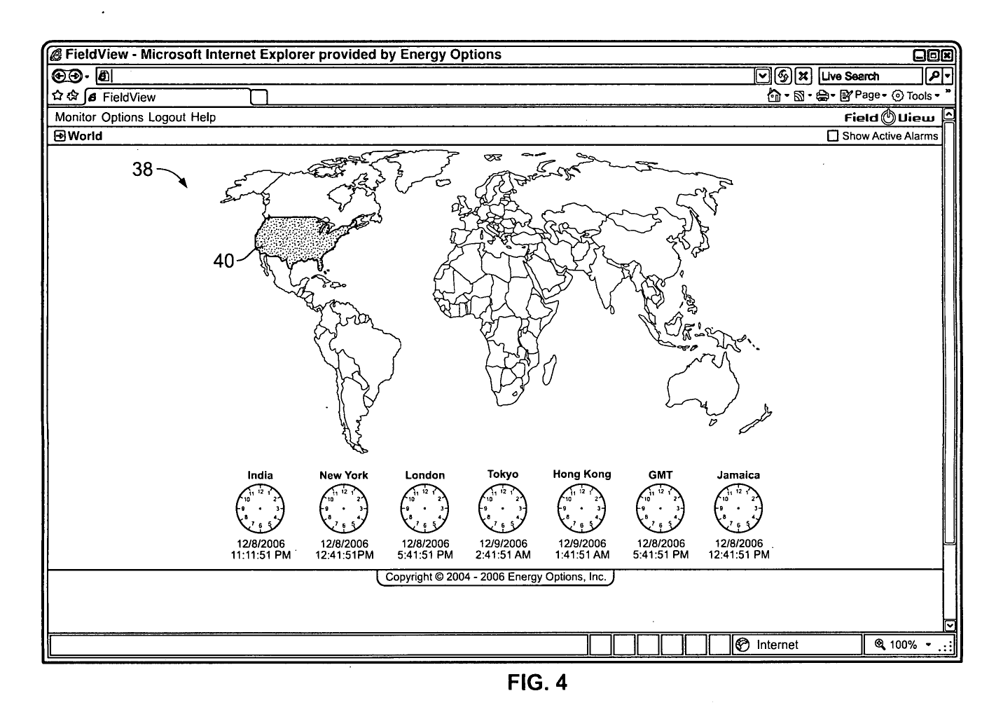

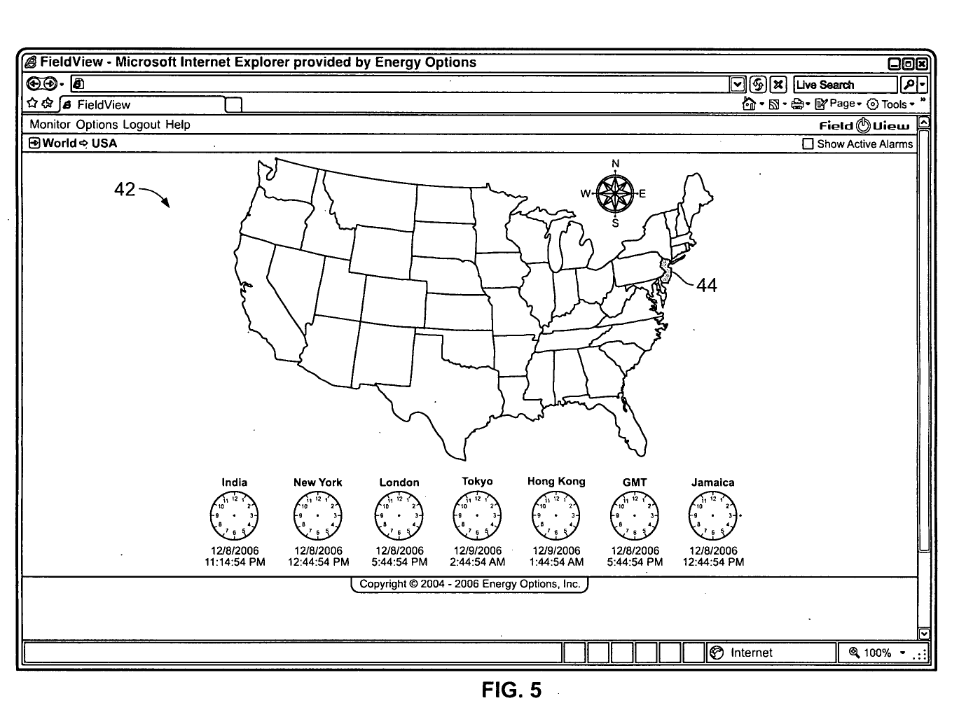

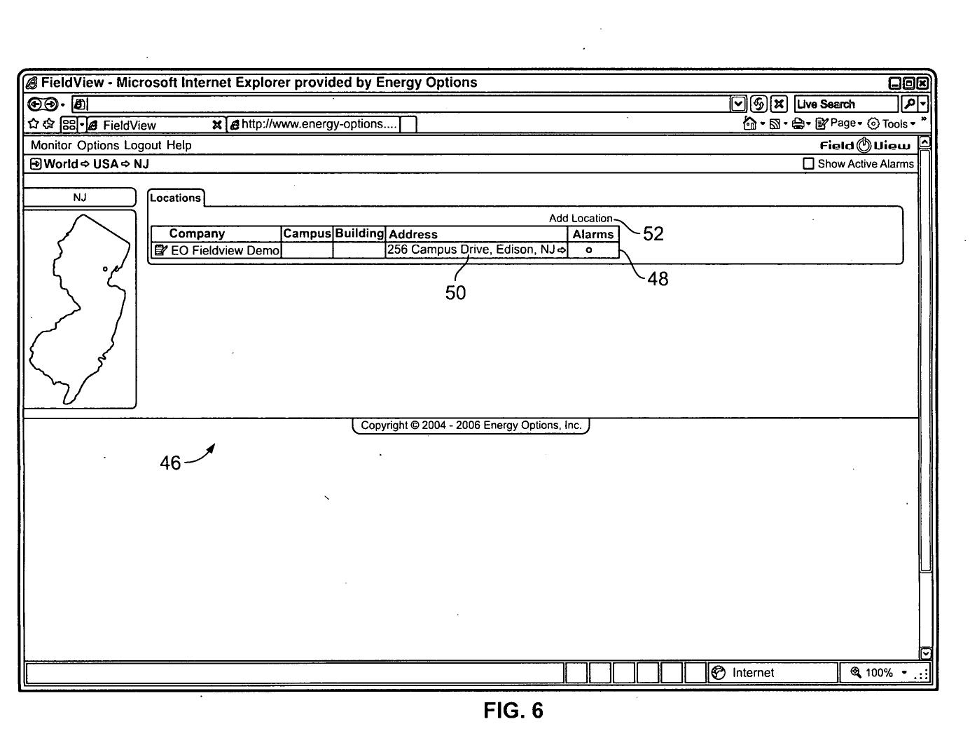

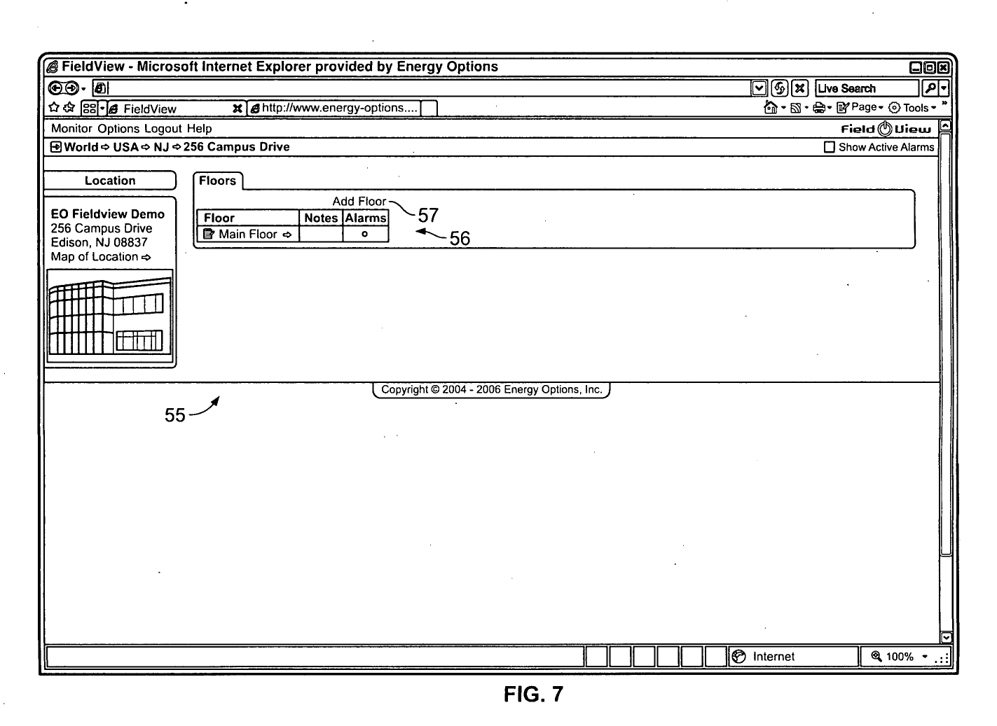

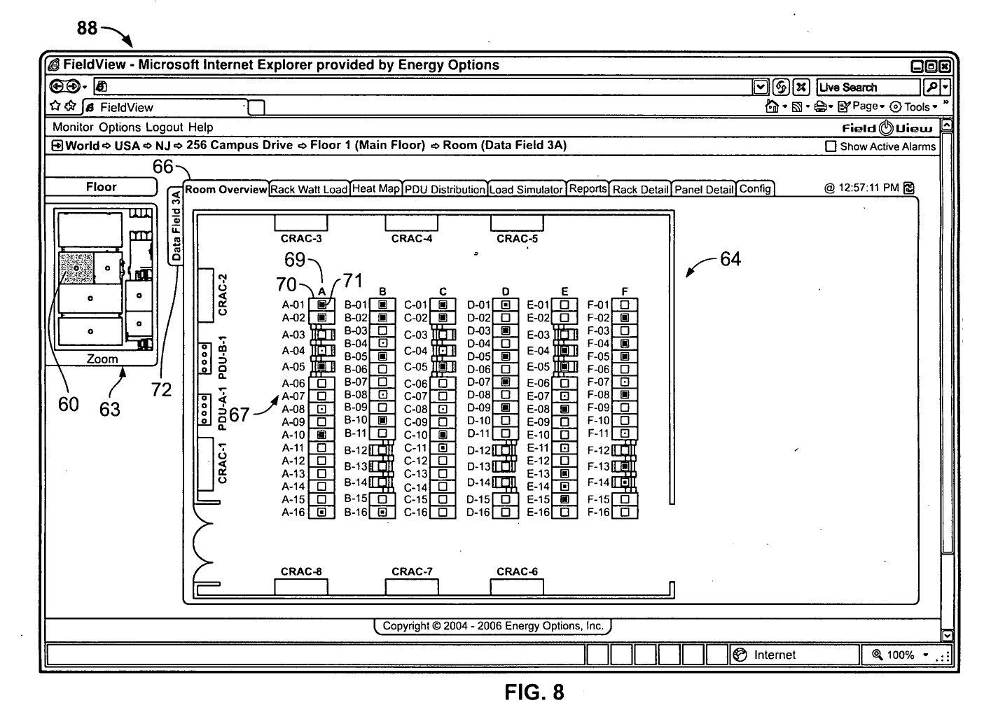

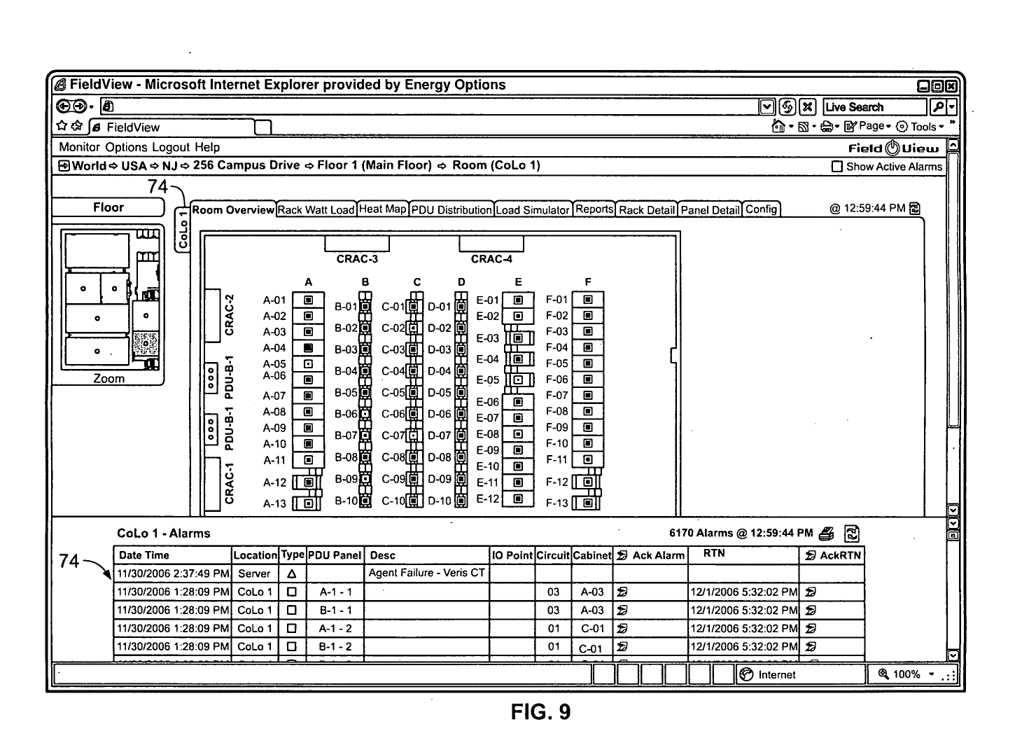

FIG. 3 is a flow diagram of the navigation of user screens, constructed in accordance with embodiments of the present invention. Referring now to FIGS. 3-9, the user accesses the application via a Web browser at a terminal 12 and is first presented with a login screen 36, from which a user enters a login and password. Once logged in, the user is presented with a world map 38 (FIG. 4). The user then selects the country 40 of the location of a facility in question. This brings the user to a country map screen 42 (FIG. 5), from which the user can select the state (province) 44. This brings the user to a locations screen 46 (FIG. 6), from which the user can select one of the address locations 48 of a facility. The user can select a facility location by street address 50, add a location 52 or edit an existing location 54. This brings the user to a floor screen 56 (FIG. 7) from which the user can select one of the floors 56 of a facility. The user can add a floor 57 or edit an existing floor 58. This brings the user to a room screen 59 (FIG. 8) from which the user can select one of the rooms 60 of a floor. The user can add a room 61 or edit an existing room 62. At the upper left hand corner of the room screen is a top plan view of the rooms on a floor plan 63, from which the user can select a room to display, which causes the room 60 to be highlighted and the floor plan of the room 64 be displayed as a map. A plurality of horizontally aligned tabs 65 align the top of the room view 60. When selecting the Room Overview Tab 66, a room map 67 is shown of equipment. The map 67 lists cabinets of equipment by column 69, with each column 69 designated by a letter prefix and the individual cabinet 70 listed by number (e.g., A-01). Each of the individual cabinets 70 has a dotted coding scheme 71, which designates an empty cabinet (e.g. A-06) indicated by an open square and progressively fuller cabinets indicated by larger squares (e.g., A-01). Tabs 72, 74 to the upper left corner of the screen (e.g. Data Field 3A and Colo 1), respectively, indicate several views for a floor plan. The “Data Field 3A” tab 72 of FIG. 8 lists equipment by occupancy, while the Colo 1 tab of FIG. 9, causes racks having alarms to be listed in a table 74.

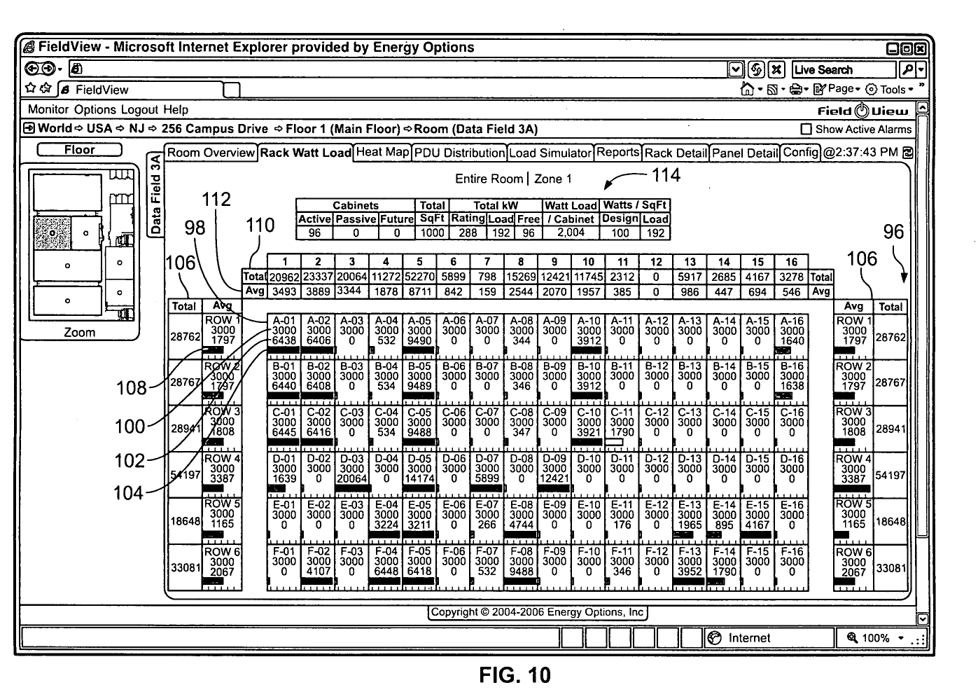

Referring, again to FIGS. 3 and 8, the tabs 65 listed along the top of a floor plan, which indicate the various view that can be displayed for a given floor, include a room overview 66, a PDU distribution 80, a reports 82, a heat map 84, config 86, and rack watt load 88. Selecting one of these tabs brings the user to new screens as shoe in FIGS. 10-18.

The details presented when selecting the Room Overview 66 provide the specifics of power and environmental conditions, including design, ratings, and loads. Individual circuits can be traced from a cabinet through a panel. A unique room identification is assigned to every room in the Room table (located in the database 32 of FIG. 3). An outline of an exemplary algorithm executed when the Room Overview 66 is selected is as follows. 1) Permissions are checked for a user to access a Room Overview 66; 2) The room identification is checked in the room table (of the database 32); 3) Alarms based on the room identification are checked in the alarms table (of the database 32); 4) Inactive and passive cabinets/racks from the racks table (of the database 32) are checked based on status while sub device from alarms table are selected based on retention (in the database 32); 5) The rack name, sub device identification, coordinates, BTU watt rating, watt Load and severity are selected from the racks and alarms table; 6) A rollover displays the Status, Rated watts, Load watts, Load % of each cabinet; 7) All the records from the PDU table are selected based on the room identification; and 8) The IO points from the IO points table are selected based on the identification of the IO point and the room.

Types of input/output (IO) points that can be displayed include: T—Temperature; H—Humidity; L—Leak Detect; and O—Disabled.

Referring to FIG. 3 and FIG. 10, the rack/cabinet watt load 88 can be selected to display the contents of a room 90 or a zone 92 via a filter 94. The cabinet/watt load 88 displays the number of active, passive, and future cabinets; the total area of the cabinet in square feet; the rating, load, and free total KW; the watt load per cabinet; and the design and load of watts per square feet. The user can view the total of the cabinet watt load across the row/column, and the average of the cabinet watt load across the row/column. FIG. 10 shows a selection by room. The room view shows cabinets now displayed along rows 96. Each cabinet (e.g., A-01) shows a display of the cabinet number 98, the rated wattage of the cabinet 100, the actual power dissipation for that cabinet 102, and an optional bar 104 indicating the degree of overload. The boxes to the left and right of the rack row list indicate total power dissipation for a row of racks 106 and the average power dissipation, rating, and a bar indicating overload 108. The boxes above the rack row list indicate total 110 and average 112 power dissipation for a column of racks. A summary chart 114 above the list of total 110 and average 112 power dissipation list the number of racks, ratings, and load for the entire floor.

An outline of an exemplary algorithm executed when the rack/cabinet watt load 88 is selected is as follows: 1) Permissions are checked for a user to access a Cabinet watt Load; 2) Room identification is checked in the room table (of the database 32); 3) The maximum length of the cabinet name is checked in the rack table based on room identification; 4) The Maximum watt Load is checked from the rack table based on the Room Identification and the Zone Number; 5) The Maximum and the Minimum number of Columns in the room are selected from the Racks table based on the Room Identification and the Zone number; 6) Colors are displayed based on the selection from the color table, and the value of the level; 7) The Columns and sum of the watt load are selected from the Rack table based on the Room Identification and the Zone number; 8) The Minimum and the Maximum of Rows are selected from the Rack table based on the Room Identification and the Zone number; 9) The Sum, Average of watt Load, and Average of BTU watt Rating are selected from Rack table based on the Room Identification and the Zone number; 10) The Active Racks, Non Active Racks, Passive, and Future are displayed based on data from the Rack table based on Status, Room and the Zone number; and 11) The Sum of the BTU watt Rating and watt Load are displayed from the Rack Table based on the Room identification and the Zone number.

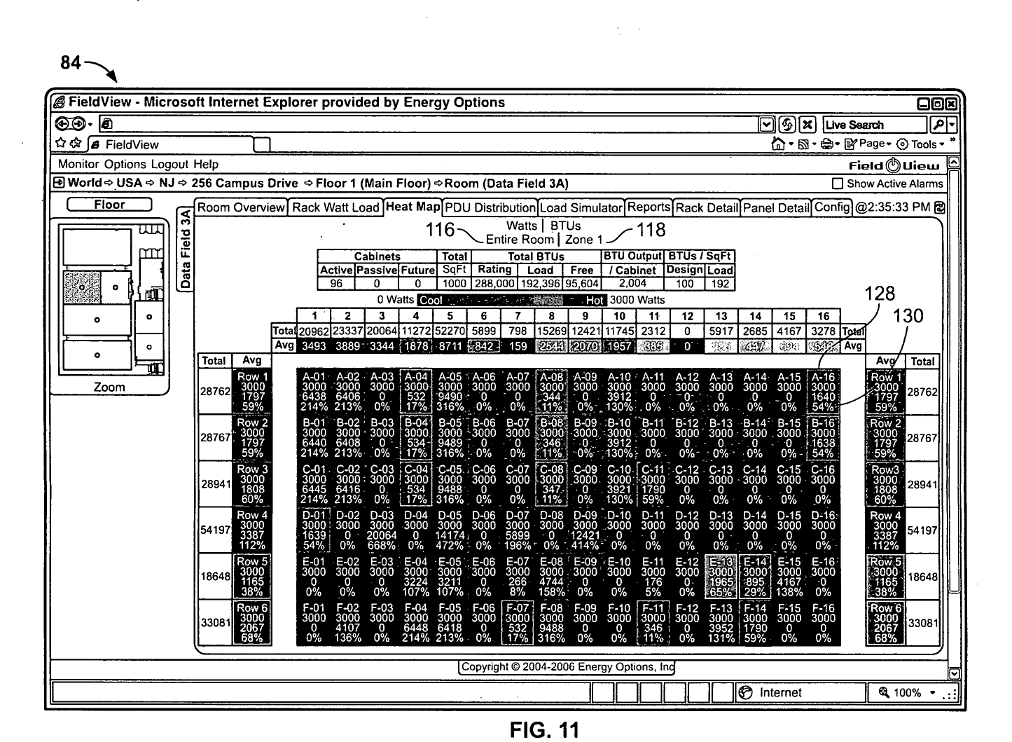

Referring to FIG. 3 and FIG. 11, the heat map 84 can be selected to display the contents of a room 116 or a zone 118 according to watts 120 and/or BTUs generated 122 via a filter 126. The heat map 84 displays the severity level for each cabinet in the room based on watts specified by a user. The heat map 84 also displays the Cabinet information, including output in watts, the average heat dissipation of each Cabinet row, and the total heat dissipation of the Cabinet row. (For example, in a block where the Color is Red, the output heat dissipation for that cabinet is attaining dissipating more then usual and needs to be checked immediately—i.e., a Critical Condition.). The user can also view the cabinet information for the entire room or for a zone. Some exemplary outputs shown in the Heat Map can include: Cabinet's Output in watts; Cabinet's Output in BTU's; Entire Room or Zone Heat Dissipation; Total and Average heat dissipation of the Cabinets;

An outline of an exemplary algorithm executed when the heat map 84 is selected is as follows: 1) Permissions are checked for a user to access the heat map 84; 2) Room identification is checked in the Room table; 3) Zonal information is checked; 4) The Sum of watt load is checked from Rack table based on Room identification and Zone number; 5) The Maximum and the Minimum number of Columns in the room is selected from the Racks table based on the Room Identification and the Zone number; 6) Colors are displayed based on a selection from the color table, and the value of the levels; 7) The above steps are repeated for each column; 8) The Columns and sum of the watt load is selected from the Rack table based on the Room Identification and the Zone number; 9) Columns, average of the watt load, and average of the BTU watt Rating are selected from the Rack table based on the Room Identification and the Zone number grouped by the column order; 10) The Active Racks, Non Active Racks, Passive, Future are displayed from the Rack table based on Status, Room and the Zone number; and 11) The Sum of the watt load and watt Rating are displayed from the Rack Table based on the Room identification and the Zone number.

FIG. 11 shows a selection by room. The layout of the heat map display is the same as for the rack watt load tab 88, except that for a given rack 128, heat generated is also expressed as a percentage 130 of the rated load. Each of the racks 128 is also color coded or grey scaled for the degree of heat generated.

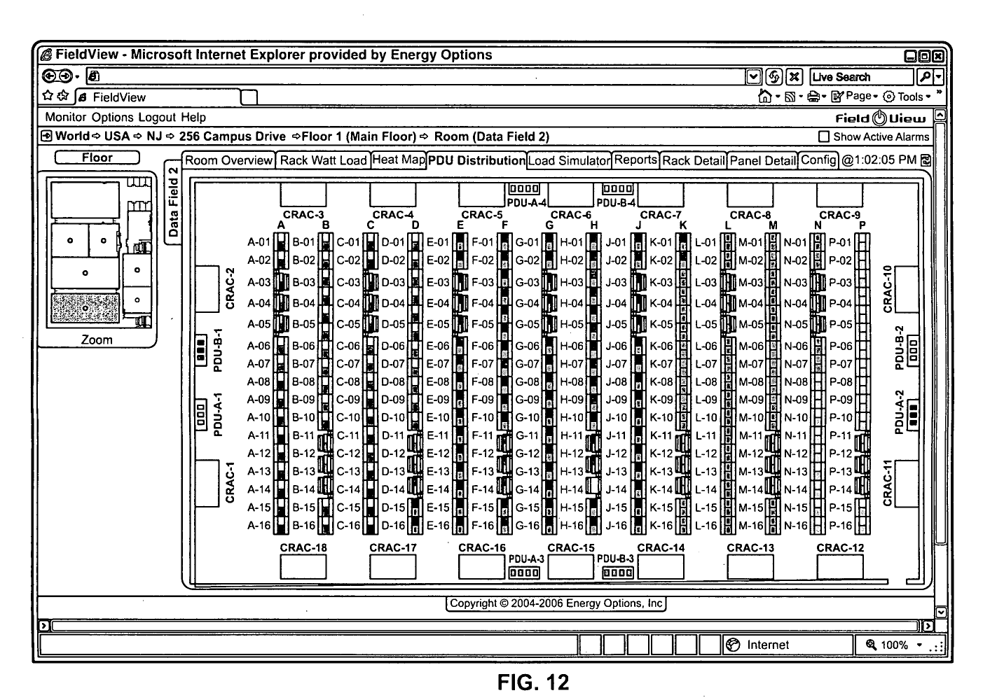

Referring to FIG. 3 and FIG. 12, the PDU Distribution 80 can be selected to display a rack details 132 directly, and/or panel details 134 via a filter 136. The PDU distribution 80 graphically depicts where power is coming from and where it is going, which can simplify capacity planning and trouble shooting. An exemplary outline of an algorithm executed when the PDU Distribution 80 is selected is as follows: 1) User Permissions are checked; 2) Room identification is checked from the Room table; 3) PDU records are selected from the PDU table based on the Room identification; 4) Records from the Rack table are selected based on the Status and the Room Identification; 5) Colors are displayed based on a selection from the color table; 6) Circuits are selected based on the Rack identification and the Panel identification from the Panels table; and 7) Panels from the PDU Panels table are displayed.

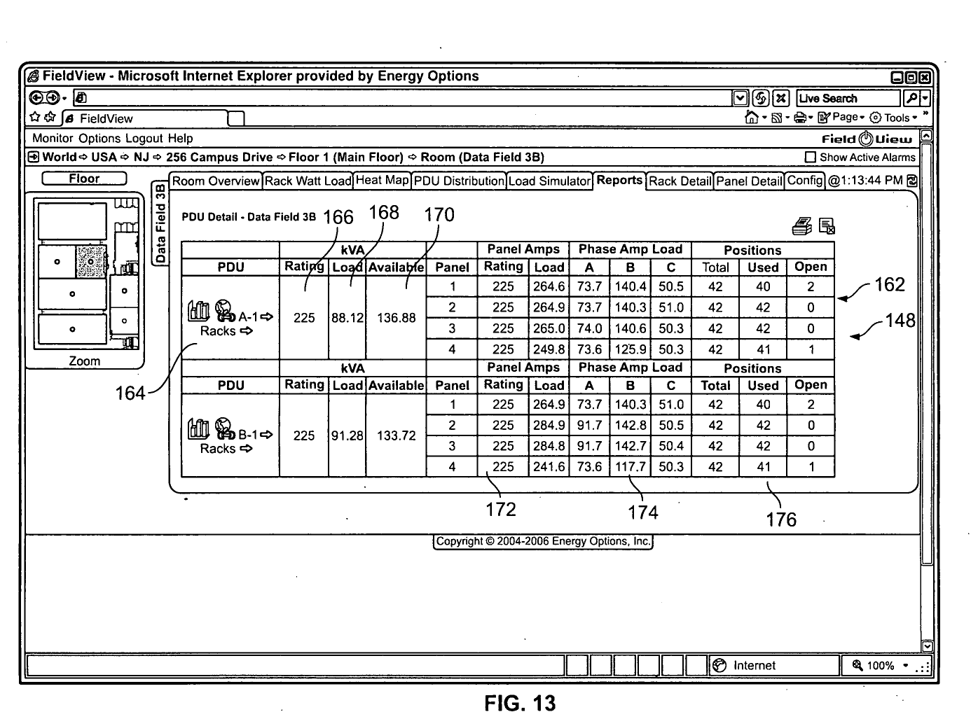

Referring now to FIGS. 3 and 13, the Reports tab 82 can be selected to display rack detail 142, PDU detail 144, AC Unit detail 146, design/load overview 148, environmental multipoint 150, room notes 152, and team circuit coverage 154 which is selectable by a filter 156 by teams in alarms 158 or all teams 160. All reports are display based on the Room to be displayed. A non-exhaustive list of exemplary reports is as follows:

Asset Management: This presents the user with the Brand and Model of the Server that is assigned to a cabinet.

GEN Detail: The GEN Detail displays a report for the GEN name, Real Power kW, Apparent Power kVA, Power Factor, Current Phase A, Current Phase B and Current Phase C for all GEN at a given Location.

UPS Detail: The UPS Detail displays a report for the UPS name, Real Power kW, Apparent Power kVA, Power Factor, Current Phase A, Current Phase B and Current Phase C for all UPS at a given Location.

CDP Detail: The CDP Detail displays a report for the CDP name, Real Power kW, Apparent Power kVA, Power Factor, Current Phase A, Current Phase B and Current Phase C for all CDP at a given Location.

PDU Detail: The PDU Detail displays a report for the PDU name, Real Power kW, Apparent Power kVA, Power Factor, Current Phase A, Current Phase B and Current Phase C for all PDU at a given Location.

PDU Panel Detail: The PDU Detail displays a report for the PDU details, the KVA, Panel Amps, Phase Amp Load, and the Positions for the PDU.

Cabinet Summary: The Cabinet summary displays the list of the Cabinets of a selected room.

AC Unit Detail: The AC Unit Detail displays a report for the AC Units, tons, the BTU rating, and the load percentage for the AC unit.

Design/Load Overview Report: The Design Load Overview displays a report of the physical, electrical, and environmental details. It also displays the various active, passive, and future cabinets and the total number of cabinets.

Team Circuit Overage: The Team Circuit Overage displays a report of the cabinet name, the team, the PDU, the Panel, the Circuit, the rating, the load, and the alarm. It also displays the team average rating and the team total load.

Environment Multi-Point: The Environment Multi-Point displays a report for the start date, end date, and the interval in seconds or minutes. It gives the user a select list of IO Points according to their types (“Temperature”, “Leak”, “Humidity” and “Disabled”).

Room Notes: This displays the date, user and the detailed note that a user submits.

Activity Log: This displays the date, user and the detailed note whenever an activity occurs.

Alarms List: This displays the complete alarms that are generated and groups based on the type: IO Panel, Circuit, GEN, UPS, CDP, PDU, Panels and the Cabinet.

Circuit Load: This displays the location, amp load and the type of the Alarm generated for a room.

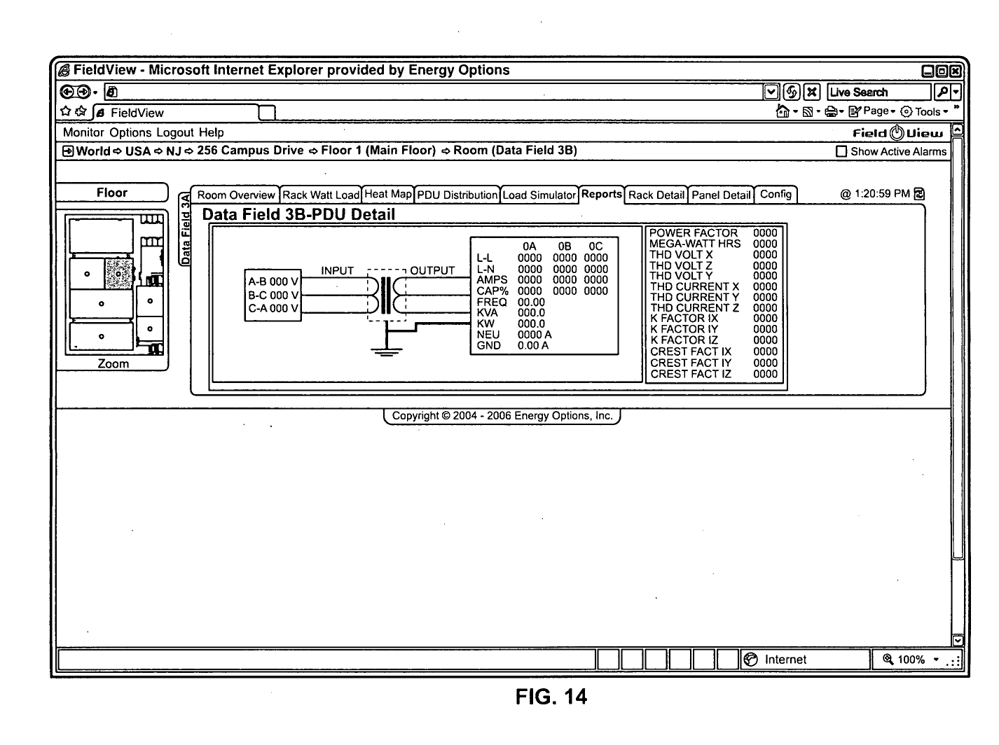

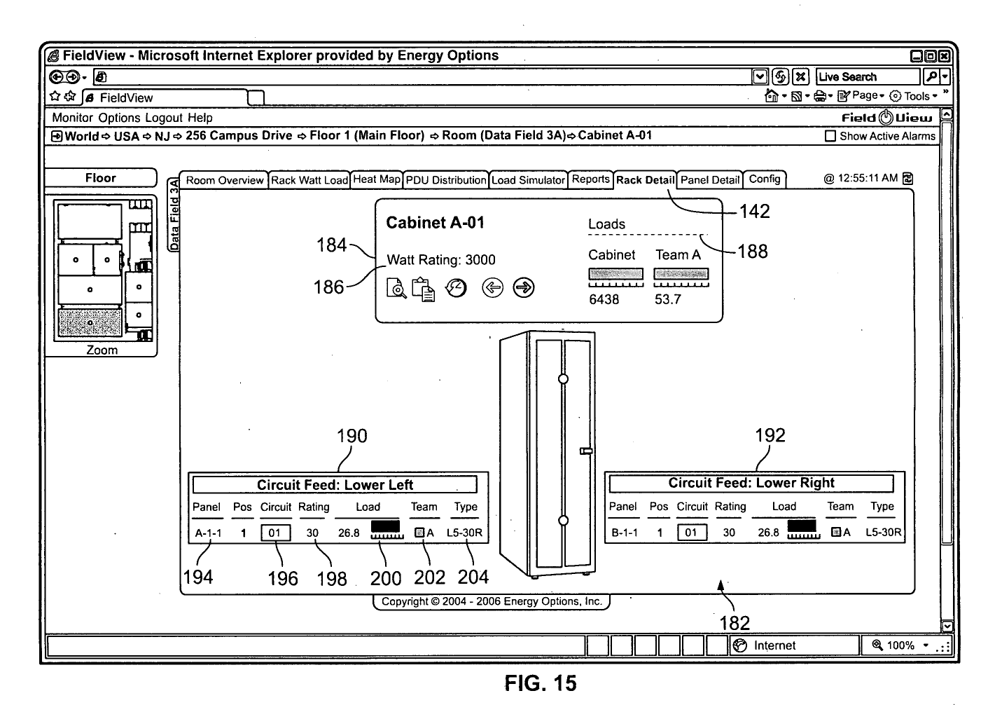

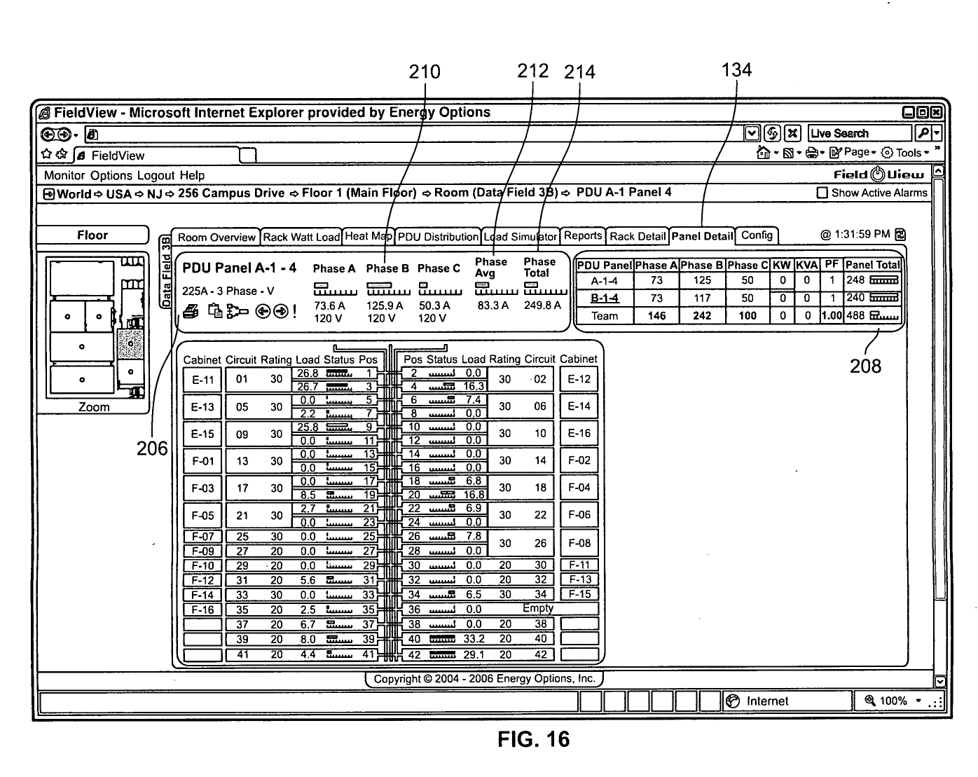

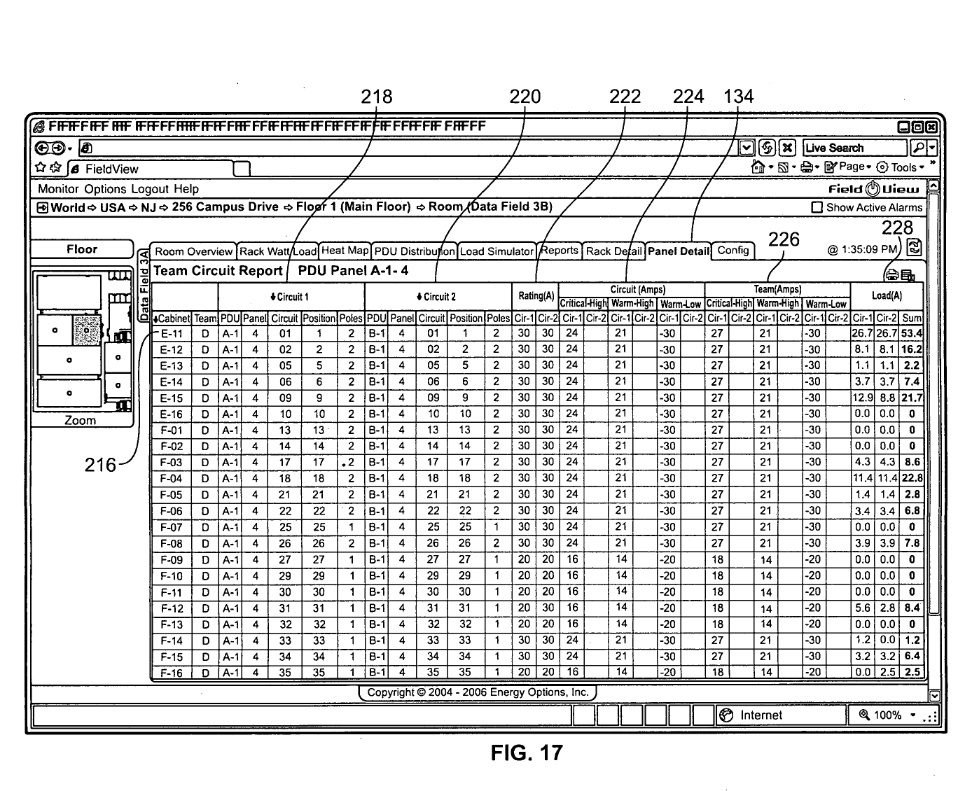

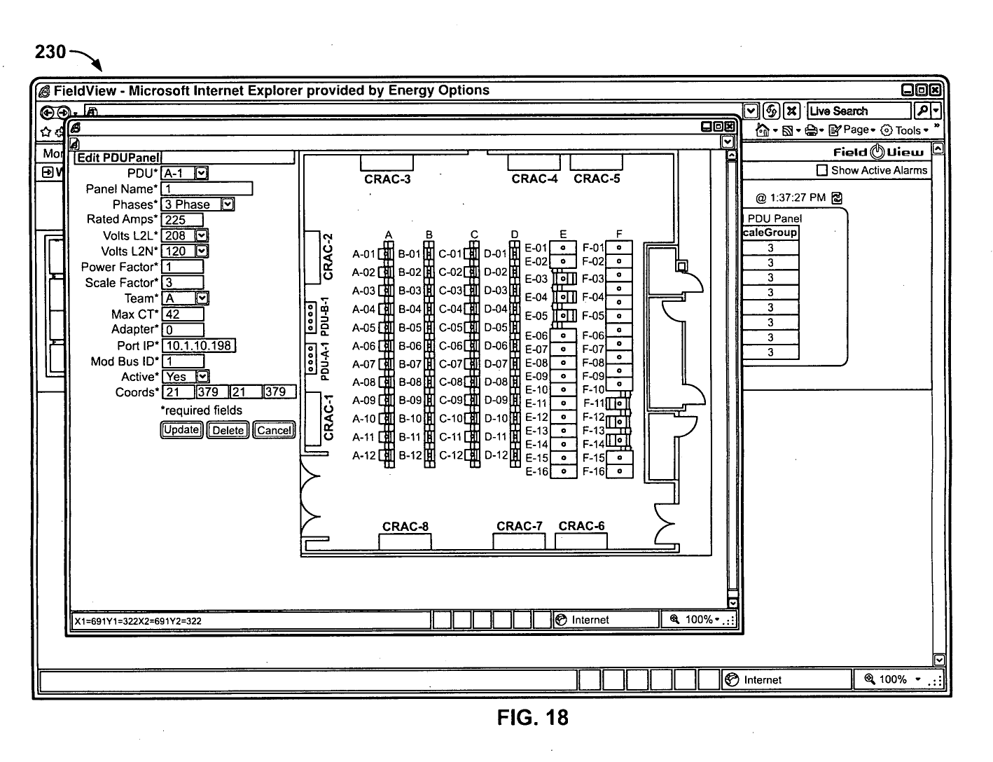

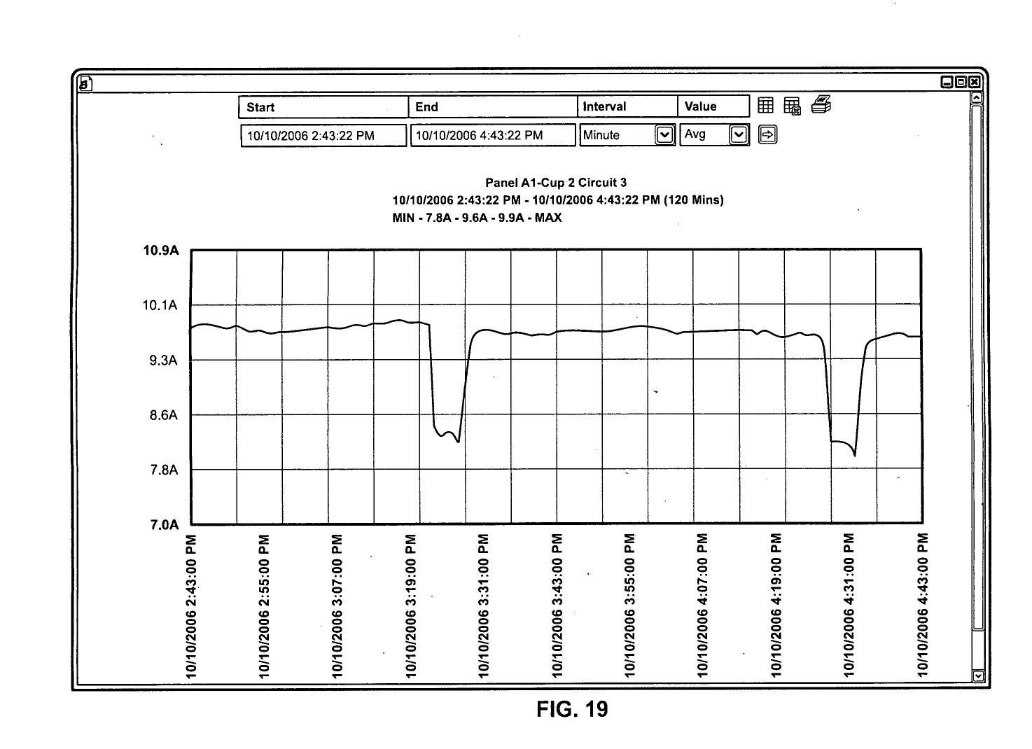

FIG. 13 shows details of displaying, a report by design/load overview 148. FIG. 13 lists each of the racks in a row 162, indicating PDU 164, rated current 166, actual load current 168, available current 170, rated and load current by panel 172, current by phase 174, and position 176. Referring now to FIG. 14, a report is generated for a particular PDU according to PDU detail, showing actual load conditions in more detail by circuit including phase. Referring, now to FIG. 15, a rack detail 132 is selected. The rack detail screen 182 shows an illustration of a particular cabinet 184, above which rated wattage 186 and actual loads 188 for the cabinet and team A is shown. To the left and right of the cabinet 184 are circuit feed graphs 190, 192 per panel, showing the panel name 194, circuit number 196, rating 198, load 200, team number 202, and circuit type 204. Referring now to FIG. 16, Panel Detail 134 is selected. The Panel Detail 134 lists individual panel details in boxes 206 and 208, including phase current 210 phase average 212, phase total 14, etc. Referring now to FIG. 17, a second panel detail 134 is selected. The second panel detail 134 lists individual panel details for a particular panel in each of the cabinets 216 based on circuit number 218, 220. Ratings for each circuit is displayed 222, circuit ratings for the entire circuit 224 and team 226 are displayed, along with the load 228. FIG. 18 shows an edit panel screen 230 after selecting the Room Overview 66 tab. FIG. 19 shows load detail vs. time from the panel detail screen 232.

The details presented when selecting config 86 provide the configuration of the Cabinets, Panels, UPS, GEN CDP, etc. Config 86 can be selected to display a PDU list 234, a PDU panel list 236, a rack list 238, an AC unit list 240, and an IO Panel list 242. A non-exhaustive exemplary list of configuration data that can be displayed includes:

IO Panel List: IO Panel List displays the basic details of the Input Output Panel List. A user can add an IO Panel, edit an IO Pane, and view the list points in the specific IO Panel.

AC Unit list: AC Unit List displays the basic details of the AC Units. A user can Add an AC Unit, and edit an AC Unit.

Cabinet List: Cabinet List displays the basic details of the Cabinets. A user can view the list of PDU Panels, add a cabinet, edit a cabinet, and view the list of servers in the cabinet.

PDU Panel List: PDU Panel List displays the basic details of the PDU Panels. A user can view the list of Cabinets add a PDU Panel, edit a PDU Panel, and view the list of circuits in the PDU Panel.

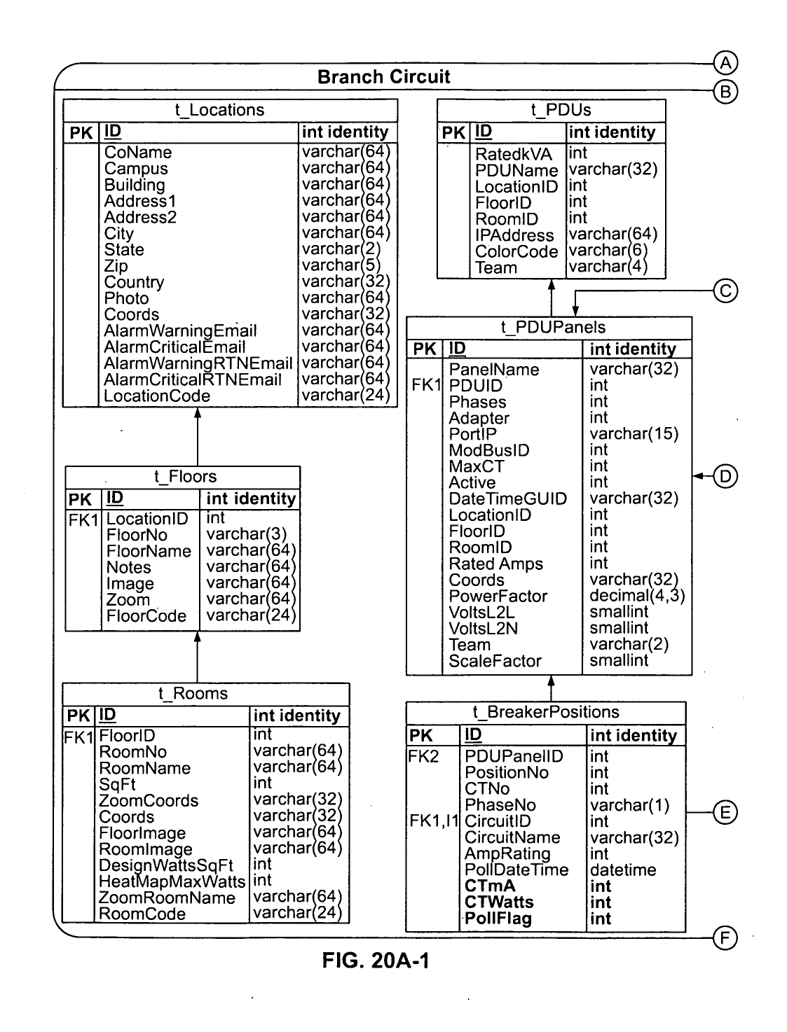

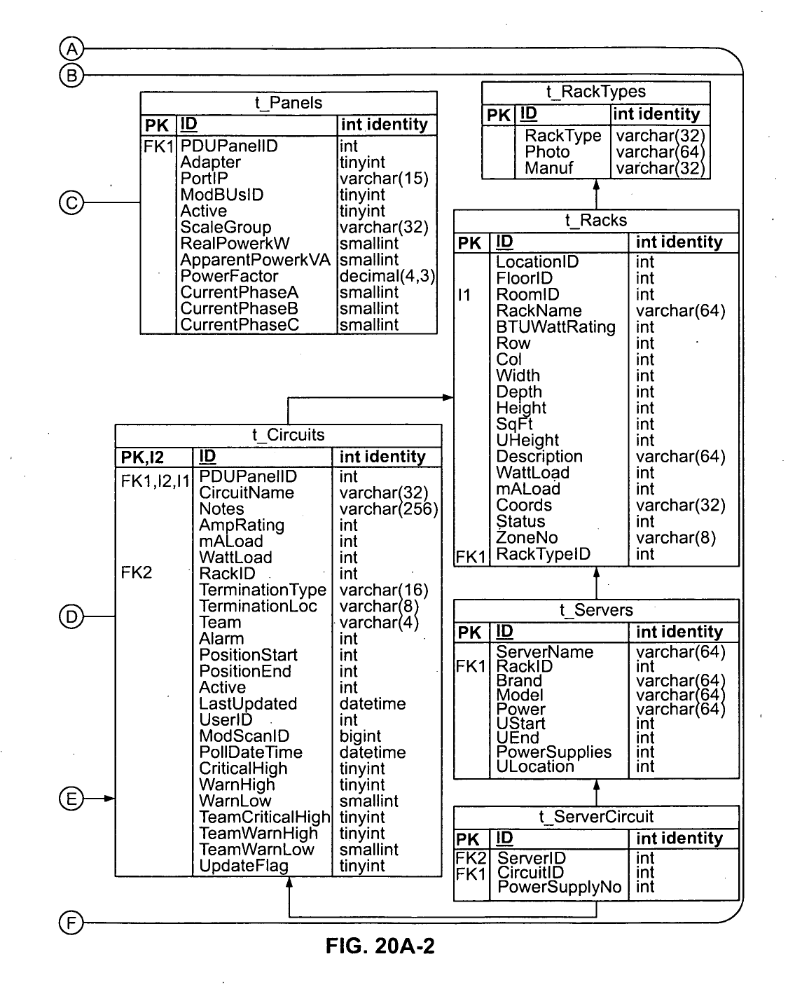

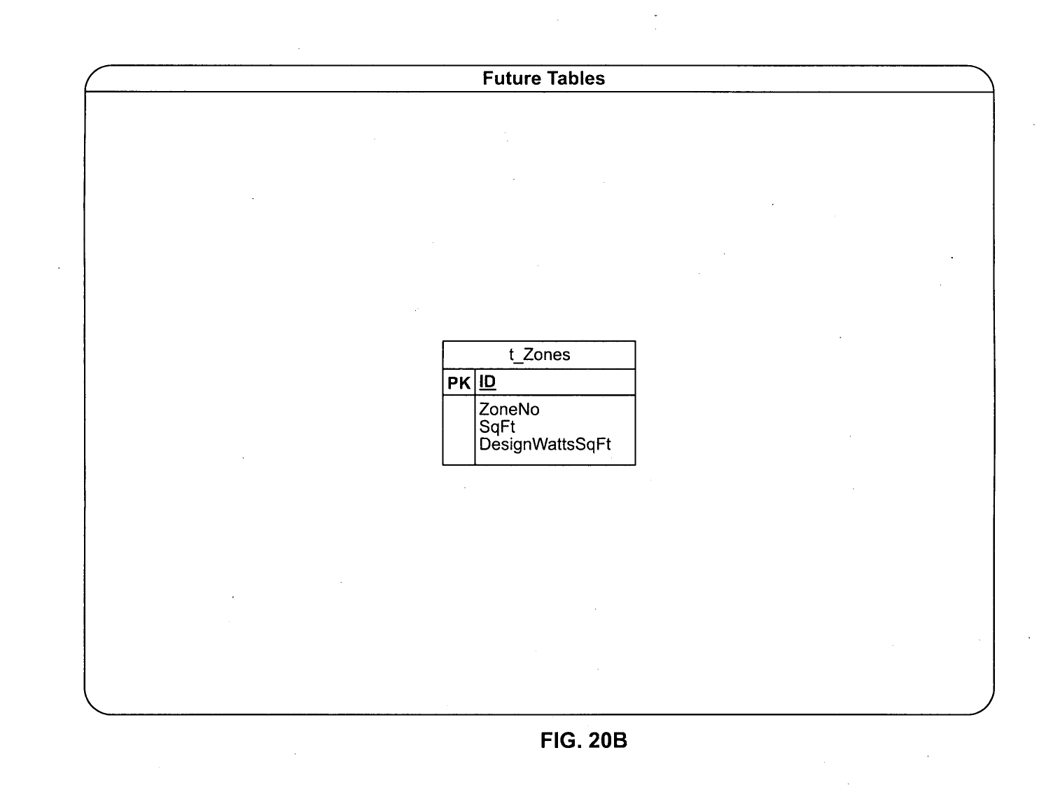

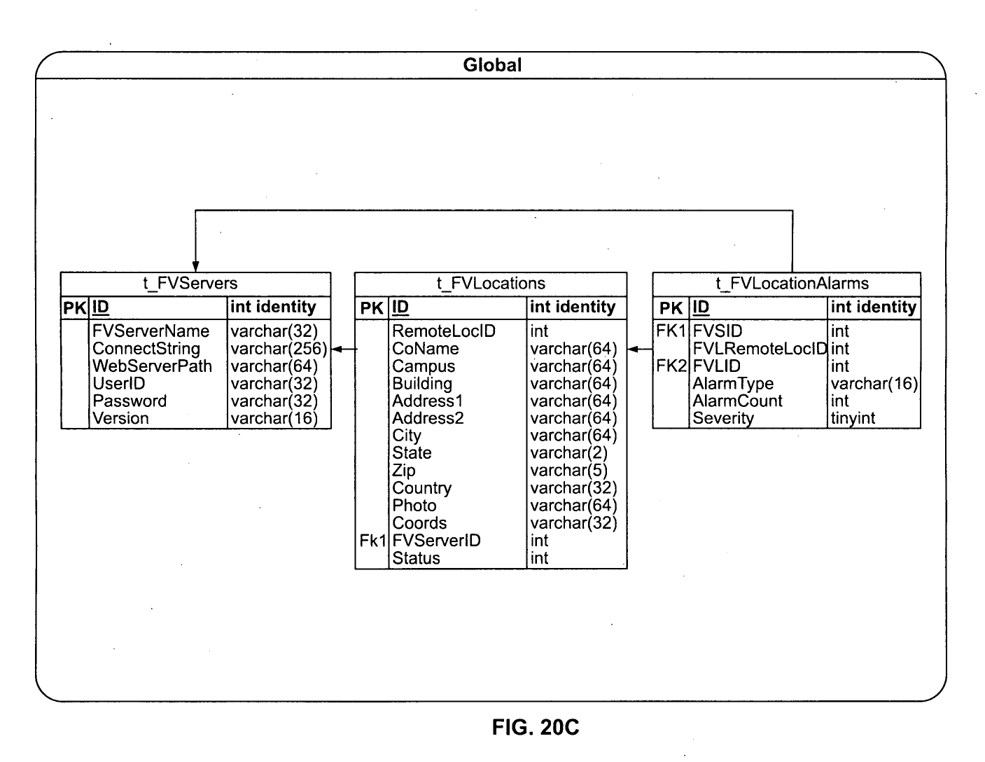

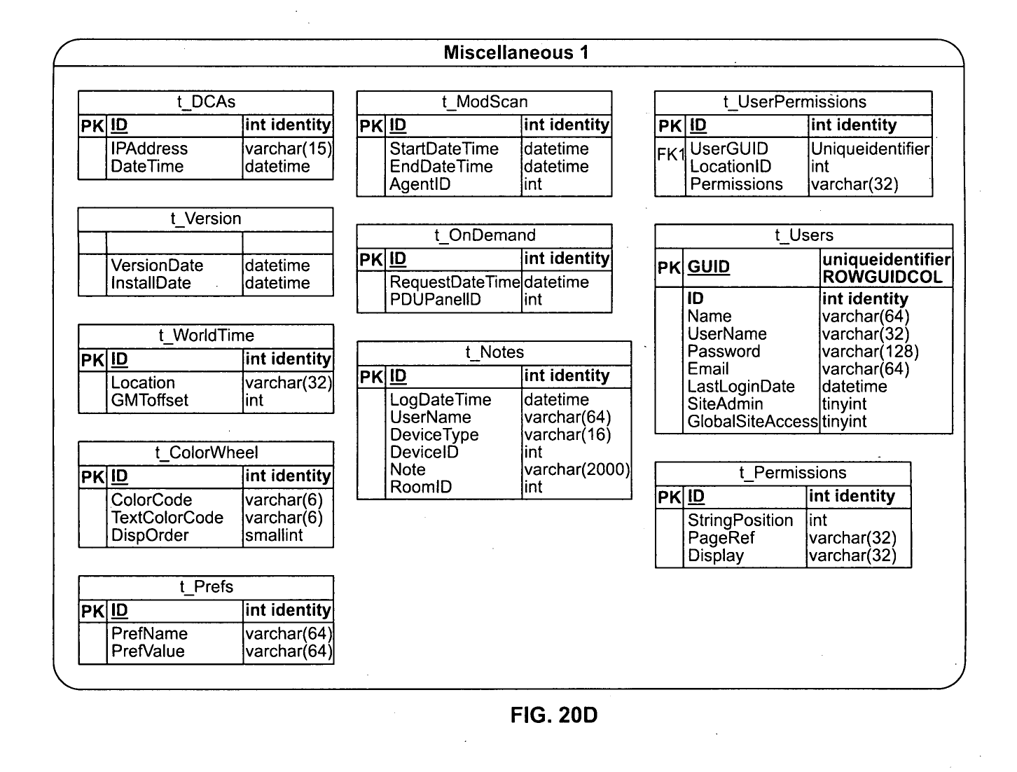

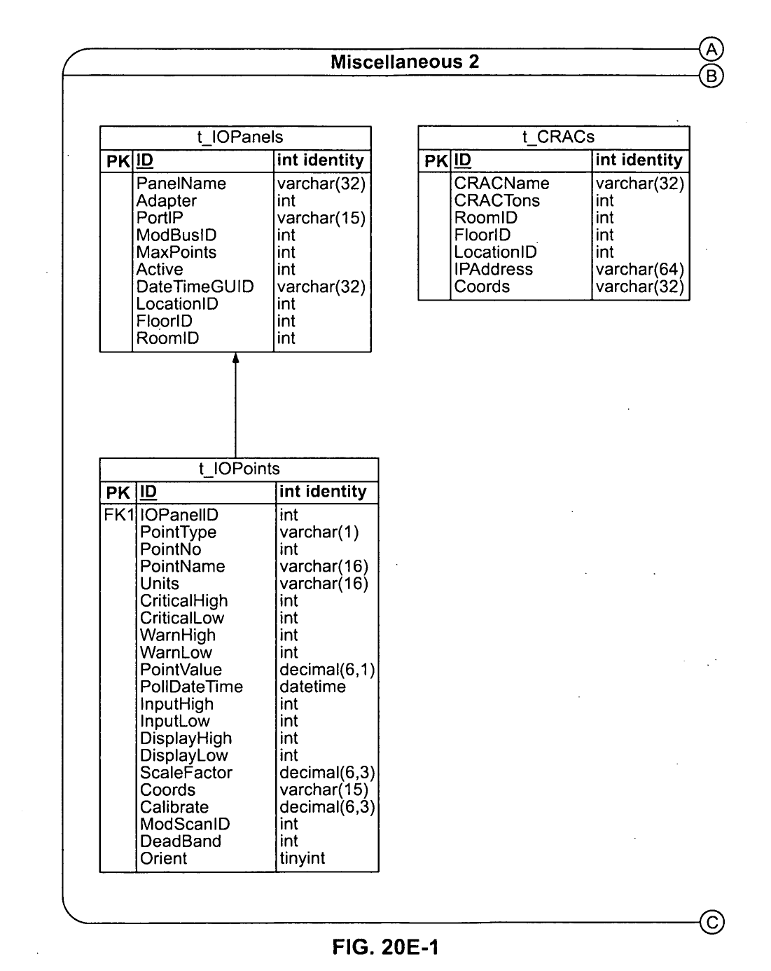

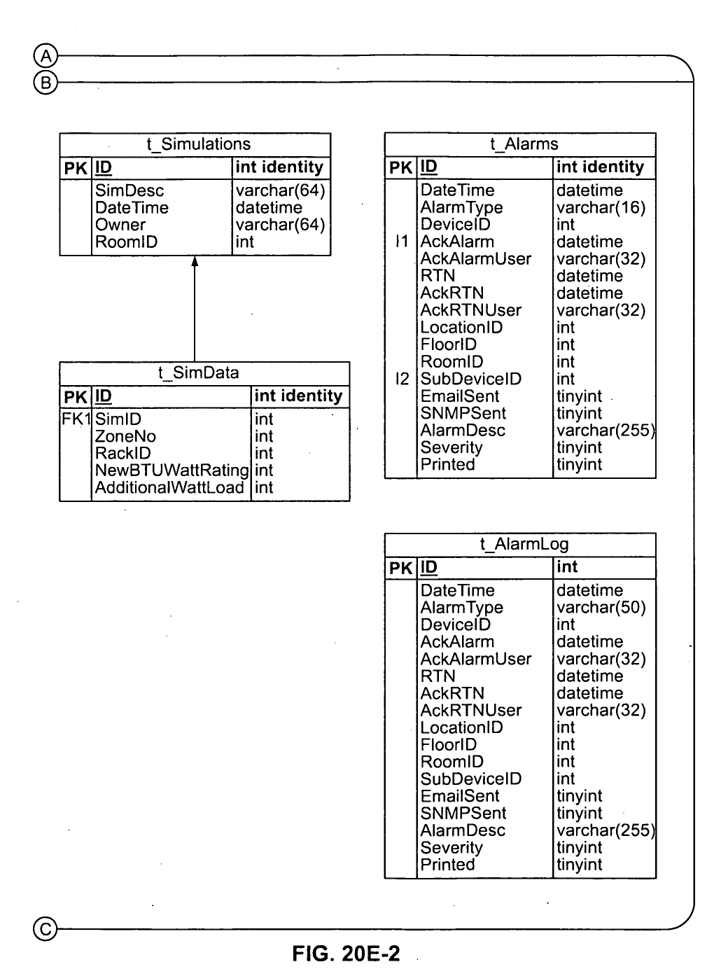

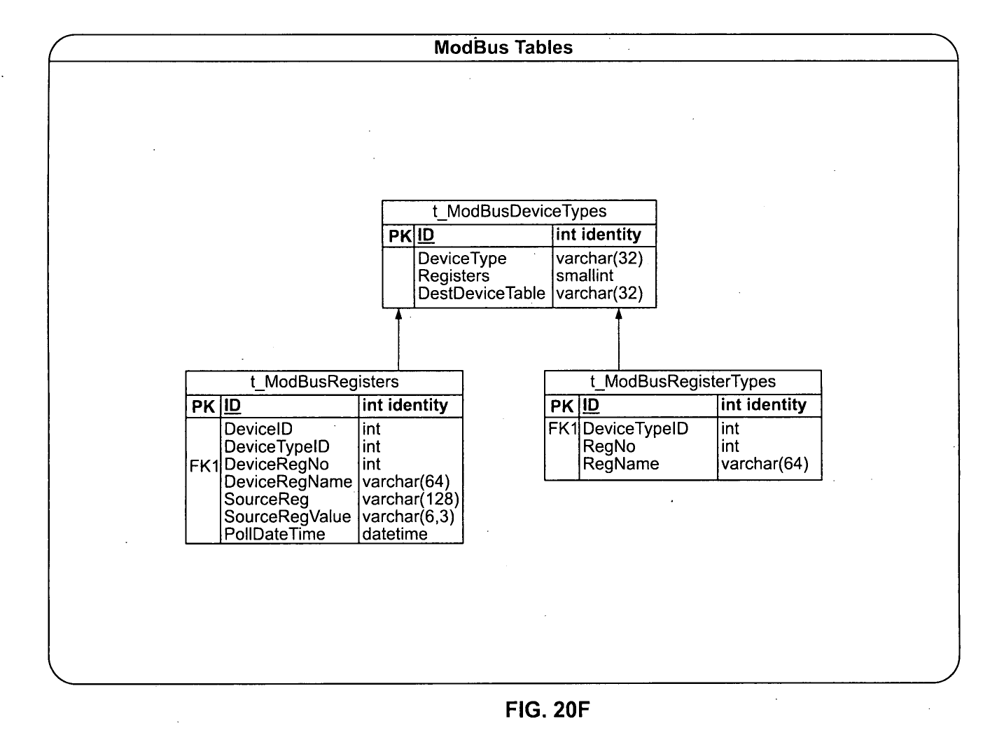

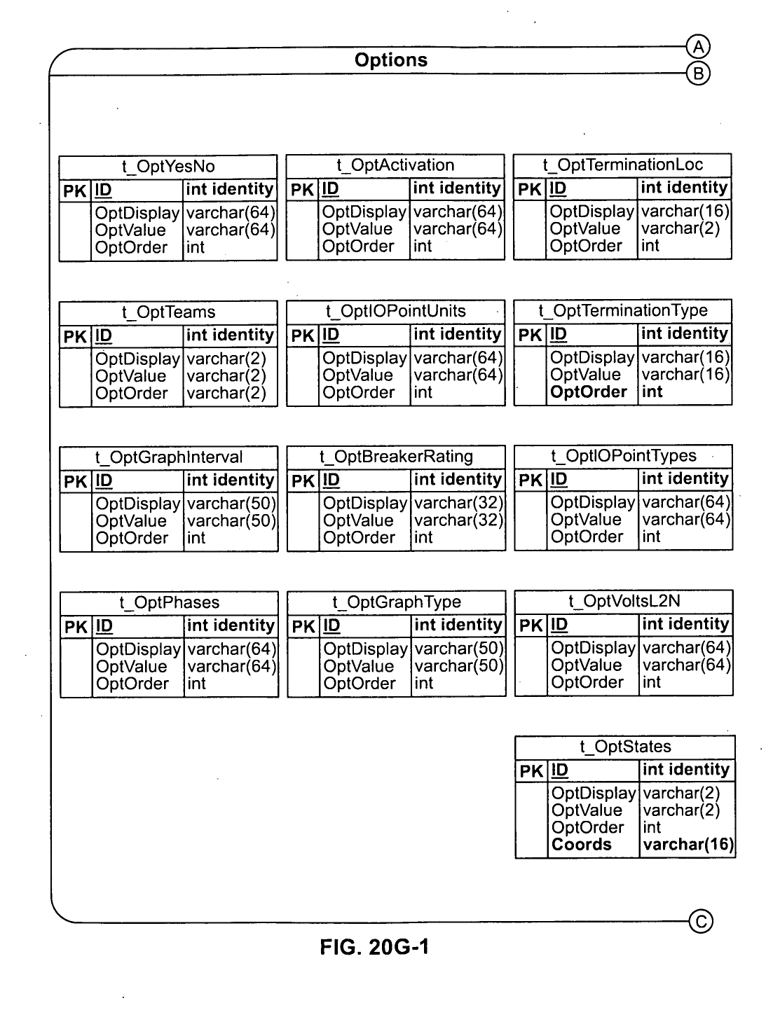

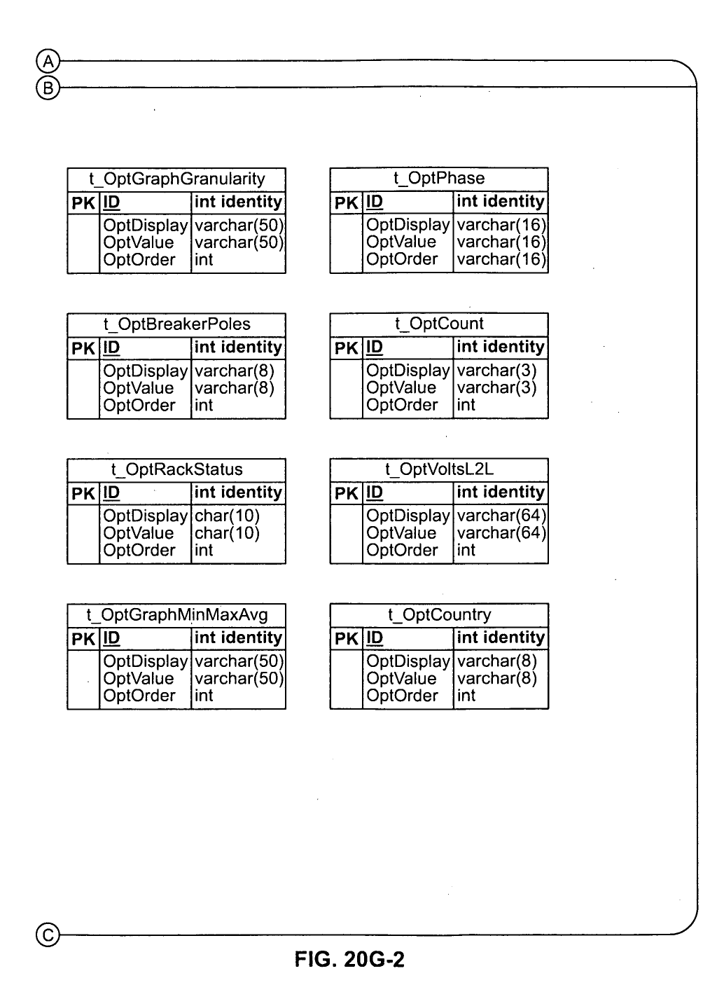

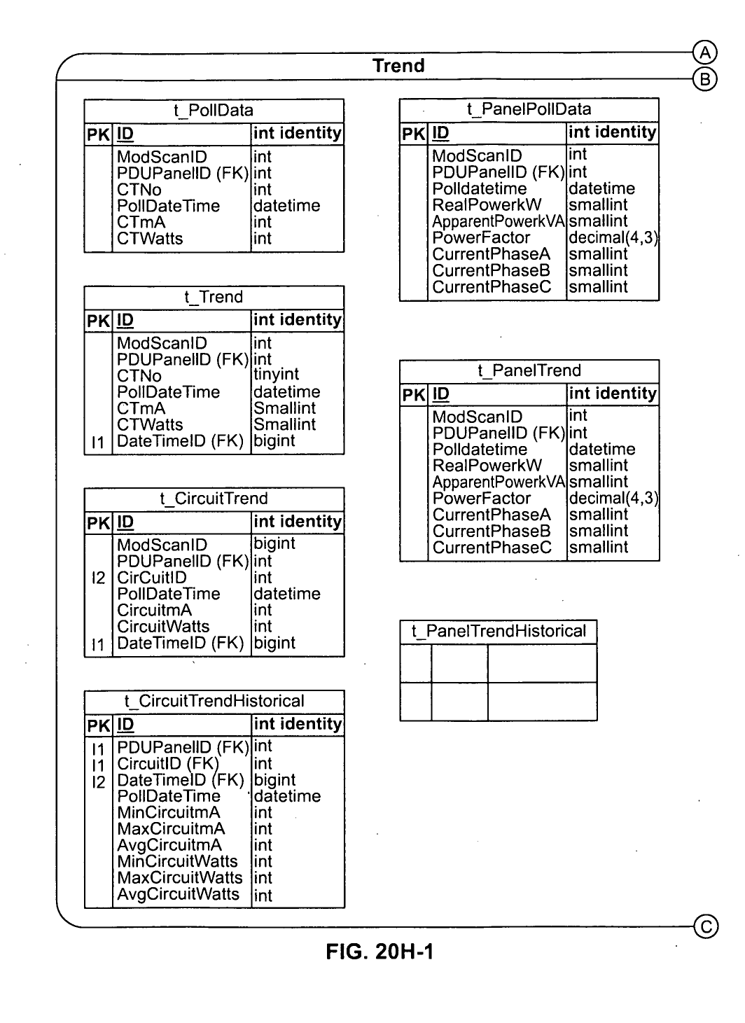

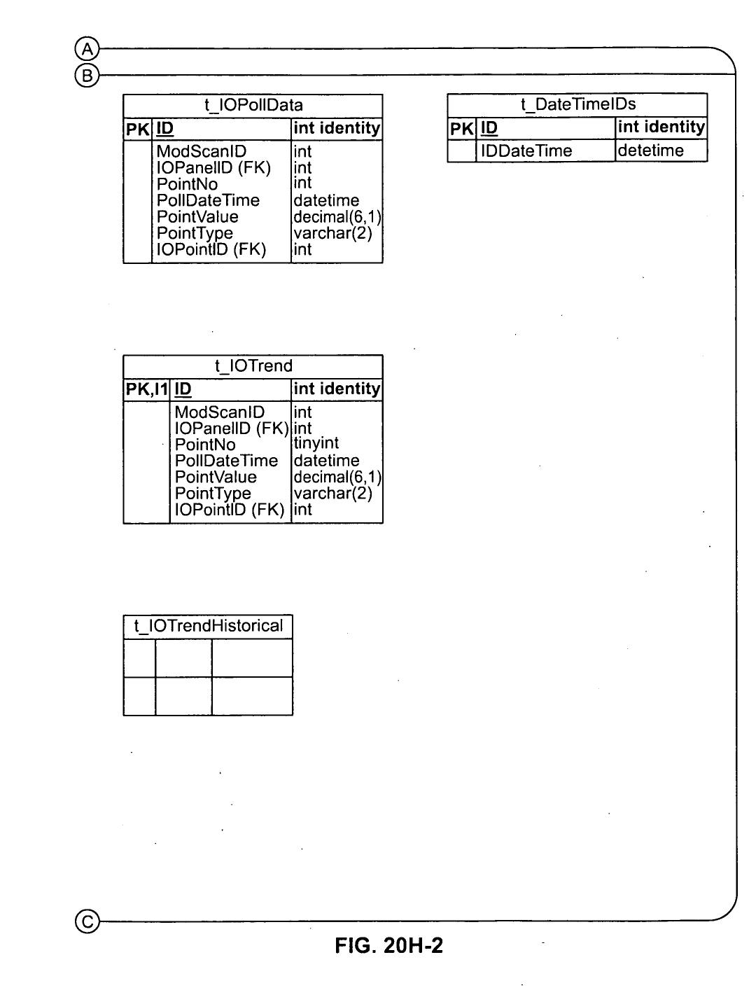

FIGS. 20A-20H are details of data tables stored in the database server of embodiments of the present invention.

While certain hardware, software, architecture, algorithm and methods are described herein, other configurations can be implanted in accordance with embodiments of the invention, as would be known to one of skill in the art.

Embodiments of the invention has numerous advantages over prior art energy management systems. A browser-based front end user interface provides the power of real time information anytime, anywhere. The use of graphical navigation which is representative of actual floor plans allows for accurate capacity planning. The present invention simplifies capacity planning and accelerates high density server deployment. Branch circuit additions, moves, and deletions are easily tracked. A Single system tracks the actual load and available power, HVAC, and cabinet capacities within a data center. Catastrophic failures are avoided by monitoring overloads and unbalanced circuit at the cabinet level. Dynamic power variations can be trended at the circuit, cabinet, room, and facility level. The system has cabinet asset management capabilities.

It is to be understood that the exemplary embodiments are merely illustrative of the invention and that many variations of the above-described embodiments may be devised by one skilled in the art without departing from the scope of the invention.

What is claimed is:

1. A method for monitoring, at a Web browser, electrical components comprising the steps of:
receiving information related to electrical components disposed in a plurality of cabinets, a portion of the cabinets being located in a first geographic location, and a second portion of the cabinets being located in a second geographic location, remote from the first geographic location;
receiving information related to the real-time characteristics of the electrical components; and
displaying, in a Web browser, a graphical representation of the cabinets, the components and the information related to the real-time characteristics of the electrical components.

2. The method of claim 1, wherein the electrical components are servers.

3. The method of claim 1, wherein the information related to the electrical components includes one or more of which cabinet the electrical components are located, the rated current draw of the electrical component, and the rated temperature of the electrical component.

4. The method of claim 1, wherein the real-time characteristics of the electrical components include one or more of the actual percentage of rated current load; the actual percentage of rated temperature, and the actual percentage power draw.

5. The method of claim 1, further comprising the step of:
displaying a plurality of graphical representation views, the views including two or more of a cabinet view, a room view, a floor view, a building view, a state view, a country view and a world view.

6. The method of claim 5, further comprising the step of:
allowing a user to navigate among then plurality of graphical representation views.

7. The method of claim 1, further comprising the steps of:
comparing the information related to the electrical components with the real-time characteristics of the electrical components;
based on the comparing, determining if an alarm condition exists.

8. The method of claim 7, wherein the alarm condition includes an over current condition.

9. The method of claim 7, wherein the alarm condition includes an over temperature condition.

10. The method of claim 1, wherein the displaying the graphical representation of the cabinets includes displaying a graphical representation of which cabinets have available physical space capacity to house additional electrical components.

11. The method of claim 1, wherein the displaying the graphical representation of the cabinets includes displaying a graphical representation of which cabinets have available electrical current capacity to house additional electrical components.

12. The method of claim 1, wherein the displaying the graphical representation of the cabinets includes displaying a graphical representation of which cabinets have available temperature capacity to house additional electrical components.

13. The method of claim 1, further comprising the steps of:
receiving information related to additional electrical components disposed in the cabinets;
receiving information related to the real-time characteristics of the additional electrical components; and
displaying an updated graphical representation of the cabinets, the components and the information related to the real-time characteristics of the electrical components, the updated graphical representation including a representation of the additional components.

14. The method of claim 1, further comprising, the steps of:
receiving information related to additional electrical components to be hypothetically disposed in the cabinets;
displaying a graphical representation of the cabinets, the components, the additional components to be hypothetically added to the cabinets, the graphical representation including a representation of what the available capacity in the cabinets would be if the additional components were to be added.

15. The method of claim 14, wherein the available capacity includes the available physical special capacity.

16. The method of claim 14, wherein the available capacity includes the available electrical current capacity.

17. The method of claim 14, wherein the available capacity includes the available electrical power capacity.

18. The method of claim 14, wherein the available capacity includes the available temperature.

19. The method of claim 1, wherein the graphical representation of the cabinets, the components and the information related to the real-time characteristics of the electrical components includes a room view, the room view including a graphical representation of rows of cabinets, the cabinets including servers, and dynamic indicators of current, power and temperatures, the dynamic indicators changing color based upon the real-time characteristics.

20. The method of claim 1, further including the step of:
providing one or more reports based upon the real-time characteristics of the electrical components.

21. The method of claim 6, further comprising the steps of:
allowing the user to navigate from a first room view in a first facility to a second room view in a second facility, wherein the first facility and the second facility are separate facilities located in different physical locations.
